(19) United States
(12) Patent Application Publication
(10) Pub. No.: US 2001/0033914 A1
(43) Pub. Date: Oct. 25, 2001

(54) Diaper changing pad

(76) Inventors: Steven C. Walker, Baldwin, MO (US); John M. Shepherd, San Antonio, TX (US); Kathryn A. Weesner, San Antonio, CA (US); Todd E. Carter, Fairfield, CA (US)

Correspondence Address: Office of the Staff Judge Advocate, U.S. Army Medical Research and Material Command, ATTN: MCMR-JA (Ms. Elizabeth Arwine), 504 Scott Street, Fort Detrick, MD, 21702-5012, US

(21) Appl. No.: 09/782,605

(22) Filed: Feb. 14, 2001

Related U.S. Application Data
(60) Provisional application No. 60/182,197, filed on Feb. 14, 2000.

(51) Int. Cl. B32B 3/30

(52) U.S. Cl. 428/167; 428/156

(57) ABSTRACT

A diaper changing pad preferably includes a top sheet, a bottom sheet, and a liquid-absorbent region between the top and bottom surfaces. The top sheet preferably is permeable to liquid. The bottom sheet preferably is impermeable to liquid. The bottom sheet also preferably includes traction bumps along the bottom side to prevent the diaper changing pad from sliding.

This application claims the benefit of U.S. provisional Application Ser. No. 60/182,197, filed Feb. 14, 2000, which is hereby incorporated by reference.

### I. FIELD OF THE INVENTION

This invention relates to a protective pad that can be placed beneath, for example, an infant during diaper changing, a patient during a hospital stay or doctor's visit, or a resident of a nursing home.

### II. BACKGROUND OF THE INVENTION

When changing a diaper of an infant, it is customary to lie the infant down on his back on a horizontal support surface, which may be a changing table, a bed, a crib, a car seat, a floor, the ground, or any other convenient surface. Depending upon the nature of the surface, it may be desirable to prevent direct contact between the infant and the support surface to avoid contamination of the support surface by the infant or the diaper, to prevent the infant from contamination by the support surface, or to increase the comfort of the infant, because the surface may be cold, hard, wet, or otherwise unpleasant to the touch.

Present pads are prone to slide and skid across surfaces when there is no friction between the surface and the pad. Surfaces that fall into this category are, for example, countertops in restrooms, tile or wood floors, and wet grass; and it these types of surfaces that babies are changed on. Additionally, typically when patients visit doctor's office they sit upon paper that rests against a slick surface bench. For a typical visit, the paper is a sufficient barrier between the patient and the bench; however, the paper is not sufficient to absorb any bodily fluid that might fall on it. Current medical pads, such as chucks, tend to slide when placed upon slick surfaces, because of the lack of friction.

### III. SUMMARY OF THE INVENTION

The present invention provides a diaper changing pad suitable for placement beneath an infant on a support surface during changing of the infant's diaper to prevent contact between the infant/diaper and the support surface.

The present invention also provides a comfortable pad for an infant to lie on during diaper changing or for a patient who is bed ridden.

The present invention also provides a pad that will not easily slide on a support surface.

The present invention further provides a method of employing a diaper changing pad.

According to one aspect of the present invention, a pad includes a top sheet, which is permeable to liquid, a bottom sheet, and a liquid-absorbent region between the top and bottom sheets. In a preferred embodiment, the bottom sheet is impermeable to liquid. The bottom sheet has a plurality of projections, such as bumps, for resisting sliding of the pad on a support surface. The projections make the pad safer to use and also help to prevent the pad from bunching up during use. The top and bottom sheets and the liquid-absorbent region may include the same material, but in a preferred embodiment, the pad includes a composite in which the top and bottom sheets are formed separately from the liquid-absorbent region.

According to another aspect of the present invention, a pad has a top sheet, a bottom sheet, first and second lengthwise ends, and a width, which is greater between the lengthwise ends than at the lengthwise ends. Such a shape provides extra width around the waist of the baby and/or patient, and thereby providing extra coverage for the area that may produce the most liquid or other bodily matter.

According to a further aspect of the present invention, a method of changing a diaper includes placing an infant on a changing pad having a top sheet which is permeable to liquid, a bottom sheet with bumps, and a liquid-absorbent region between the top and bottom sheets. The infant's diaper is then changed while the infant lies on the changing pad. The changing pad may then be discarded after the diaper is changed.

A changing pad according to the present invention is particularly suited for use when changing diapers, but can also be employed in a variety of other ways. For example, it can be used beneath a patient in a hospital when a dressing protecting a wound is being changed, it can be placed beneath a patient who is using a bed pan, or it may be used as a general purpose protective surface on which to place an infant, an adult, or an animal in order to prevent contact by or of the infant, adult, or animal with a surface such as a bed or a table.

### IV. BRIEF DESCRIPTION OF THE DRAWINGS

FIG. 1 is a top plan view of an embodiment of a changing pad according to the present invention.

FIG. 2 is an exploded isometric view of the embodiment of FIG. 1.

FIGS. 3(a)-(g) illustrate alternative bottom plan views of the embodiment of FIG. 1. FIG. 3(h) illustrates an alternative side view of the embodiment of FIG. 1

FIGS. 4(a)-(d) depict alternative shapes and bottom plan views of the invention.

### V. DESCRIPTION OF THE PREFERRED EMBODIMENTS

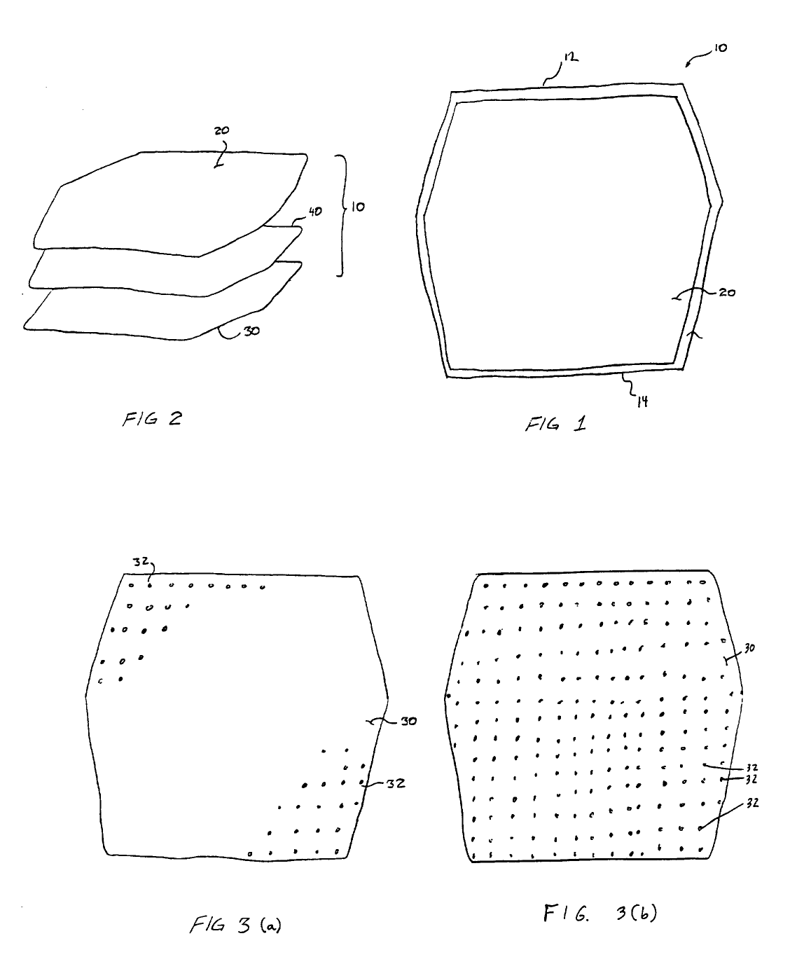

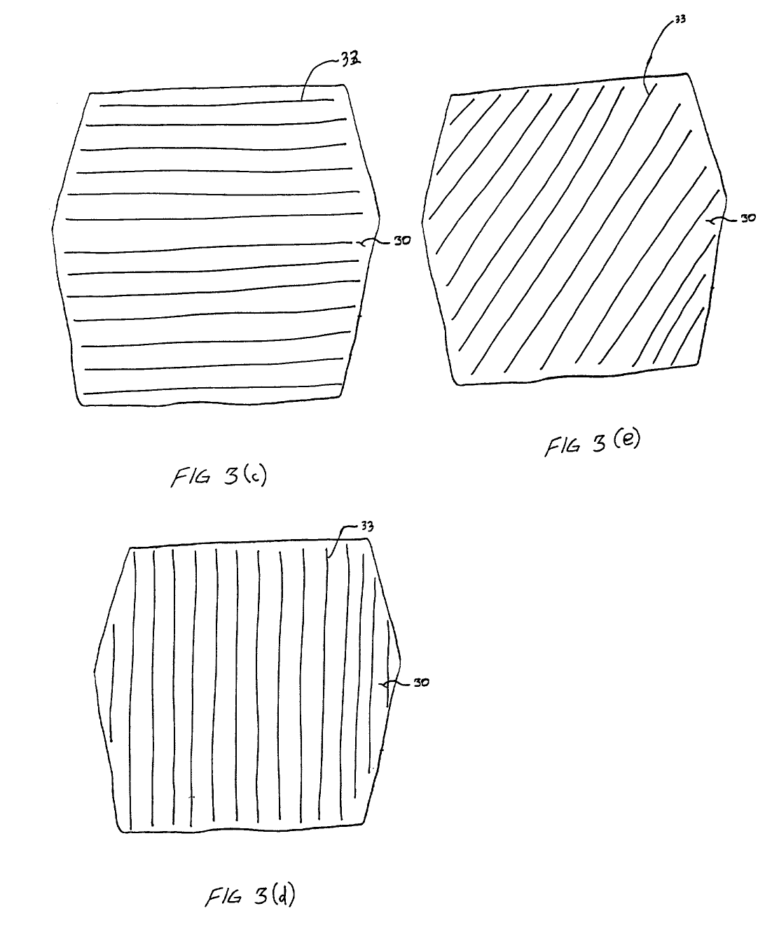

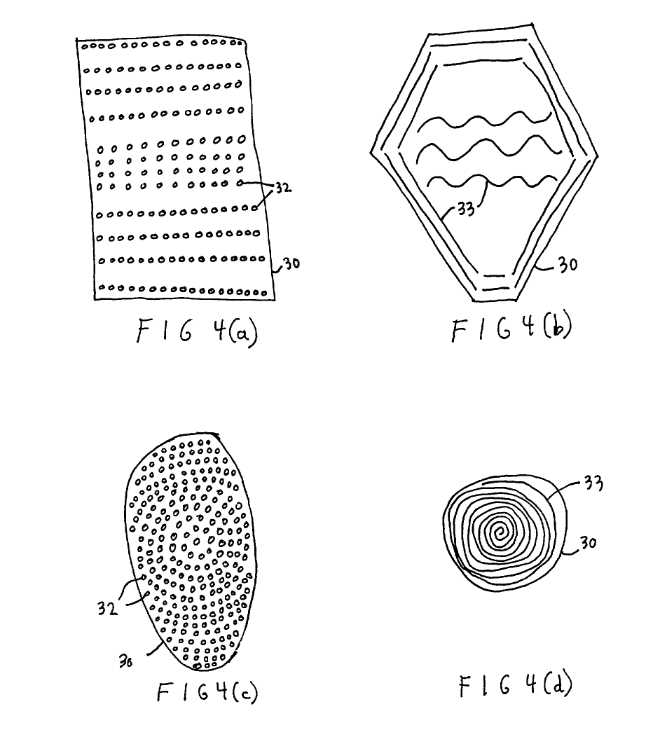

FIGS. 1-3(h) illustrate an embodiment of a diaper changing pad 10 according to the present invention. The illustrated embodiment includes a top sheet 20 for supporting an infant during diaper changing and a bottom sheet 30 which can rest on a table, a bed, or other support surface during diaper changing. The pad 10 may have any desired shape as viewed in plan that enables it to support a desired region of an infant's body, such as rectangular, polygonal, oval, circular, or other shape as illustrated in FIGS. 4(a)-(d). The pad 10 may have any desired dimensions. Preferably, the pad 10 is large enough to support the entire body of the baby and/or patient. There is no upper limit on the size of pad 10.

The illustrated pad 10 preferably is hexagonal with a width that increases linearly from the lengthwise ends 12, 14 of the pad 10 towards its lengthwise center. The two lengthwise ends preferably have the same width, and the region of greatest width preferably is midway between the two lengthwise ends 12, 14. A hexagonal shape is advantageous because it increases the width of the pad 10 approximately where the baby and/or patient's waist is located. Preferably, the pad 10 will be manufactured to have sufficient length to provide a barrier for the full height of the baby and/or patient. Alternatively, the pad 10 may be rectangular instead of hexagonal shape as illustrated in FIG. 4(a).

The top sheet 20 of the pad 10 is preferably highly permeable to urine or other aqueous fluids. The pad 10 preferably includes an absorbent region 40 between the top and bottom sheets 20, 30. The absorbent region 40 preferably absorbs liquids which permeate the top sheet 20. The top sheet 20 of the pad 10 may simply be the top surface of the material forming the absorbent region 40. In many cases, it is convenient if the top sheet 20 and the absorbent region 40 are made of different materials, since a material having good absorbency (a desirable property for the absorbent region 40) may not have good resistance to abrasion (a desirable property for the top sheet 20) and may tend to wear under contact with an infant.

In the present embodiment, the top sheet 20 is formed separately from the absorbent region 40. The top sheet 20 may be made of a wide variety of liquid permeable materials, such as meshes, moisture permeable webs, woven or non-woven fabrics that are sufficiently porous to permit liquids to pass therethrough, or films having pores or other openings through which liquid can readily pass. The top sheet 20 is preferably tough enough not to abrade during use but smooth enough not to irritate the skin of an infant and/or a patient lying on the pad 10. Fabrics used as facing materials for conventional disposable diapers are particularly suitable for the top sheet 20. Also, it is preferable that the top sheet 20 provides a separation barrier between the infant and the liquid in the absorbent region 40.

The characteristics of the absorbent region 40 can be selected based on the amount of liquid, which is expected to enter this region 40 through the top sheet 20 during diaper changing. Any material having the desired absorbency can be employed, with materials employed for the absorbent panels of conventional disposable diapers being particularly suitable. In the present embodiment, the absorbent region 40 preferably has a dry uncompressed thickness of approximately 0.06 to 0.25 inches, and more preferably the dry uncompressed thickness is about 0.125 inches. Preferably, the absorbent region 40 material will expand as liquid is absorbed.

The bottom sheet 30 of the pad 10 may simply be the bottom surface of the absorbent region 40. More preferably, the bottom sheet 30 is a separate layer having different properties from the absorbent region 40, for example, to protect the absorbent region 40 against abrasion from the underlying surface and/or to prevent the passage of liquids through the bottom sheet 30.

In the present embodiment, the bottom sheet 30 is formed separately from the absorbent region 40 and extends over the entire surface area of the bottom of the absorbent region 40. The bottom sheet 30 preferably has a low permeability to liquid so that liquid in the absorbent region 40 or liquid contacting the outer surface of the bottom sheet 30 will not readily pass through the bottom sheet 30. The degree of liquid permeability may depend upon the environment where the pad 10 is to be used. For example, if the pad 10 needs to be used in an environment that is damp such as outdoors or at a swimming pool, a material such as a plastic membrane which is substantially impermeable to liquid may be suitable. If the pad 10 is intended for use in drier settings, a higher degree of permeability, such as that possessed by woven or non-woven fabrics may be acceptable. Materials used as the backings for conventional disposable diapers generally have satisfactory properties.

In order to prevent the pad 10 from sliding with respect to a changing table or other support surface on which it is placed during diaper changing, the bottom sheet 30 of the pad 10 preferably is formed with members which increase the grip of the bottom sheet 30 against a surface on which it rests. In the present embodiment, the bottom sheet 30 preferably includes a plurality of projections in the form of round bumps 32 to improve its grip, and thus increase the frictional forces between the pad 10 and the support surface. The bumps 32 preferably are integrally formed with the bottom sheet 30. Alternatively, the bumps 32 may be separately formed and then joined to the bottom sheet 30 by bonding or other suitable method; and in this alternative it is preferable that the bumps 32 are rubber, silicon, or other similar material.

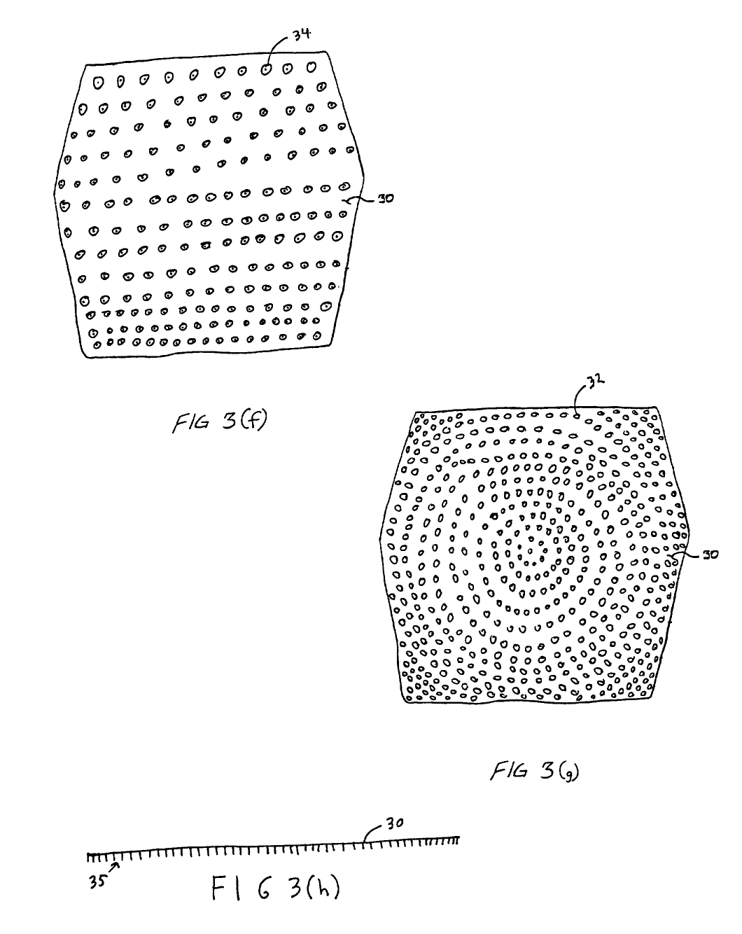

Other possible shapes for projections for increasing the grip include ridges 33 (FIGS. 3(c)-(e), 4(b), (d)), suction cups 34 similar to the underside of shower mats (FIG. 3(f)), raised bumps, needle-like shapes, or a pattern of string appendages 35 (FIG. 3(h)) similar to a field of grass. The bumps 32 may be arranged in a regular array or in any other desired pattern. The projections on the bottom of the bottom sheet 31 may be arranged in a variety of ways as illustrated in FIGS. 3(a)-(g) and 4(a), (c).

Additionally, the projections may be different sizes to each other such that there may be small projections and large projections both used. As illustrated in FIG. 4(a), the bumps 32 may be more concentrated in the central area and sparser towards the ends and/or sides. FIG. 4(b) illustrates a combination of straight ridges 33 and curved ridges 33 such as sinusoidal curves. FIG. 4(d) provides an example of a spiral ridge that may maintain the same distance between neighboring ridge portions or alternatively may have varying distances between neighboring ridge portions across the bottom sheet 30. Preferably, the projections will be formed in a regular recurring pattern to ease manufacture of the pad 10. The bumps 32 not only increase the safety of the pad 10 by immobilizing it with respect to a support surface, they also help to maintain the pad 10 in a smooth and unwrinkled state by preventing shifting of different portions of the pad 10 with respect to each other during diaper changing.

It may be desirable to seal the outer periphery of the pad 10 to prevent liquid, which enters the absorbent region 40 from leaking to the outside of the pad 10 through the periphery. In the present embodiment, the bottom sheet 30 preferably is somewhat larger in area than the top sheet 20 and the absorbent region 40 so that it can be folded over to the top side of the top sheet 20 and then be secured in place to seal the outer periphery of the pad 10. The folded over portion of the bottom sheet 30 may be secured in place by bonding with, for example, an elastic or inelastic adhesive, stitching, riveting, heat sealing, sonic sealing, or any other desired method.

Another way to seal the outer periphery of the pad 10, without folding over the bottom sheet 30, is to run a bead of adhesive around the periphery to join the different layers to each other. An alternative to gluing/bonding the two sheets together is to stitch, rivet, heat seal, or sonically seal the two sheets together. Preferably, the top sheet 20 and the bottom sheet 30 are equal size and larger such that the absorbent region 40 is nested within the area between the top sheet 20 and the bottom sheet 30. The different layers may also be joined to each other in locations other than along the periphery of the pad 10 by bonding, stitching, riveting, interlocking of the fibers in adjoining layers, or other methods.

The pad 10 is preferably flexible so that prior to use, it can be stored in a rolled-up or folded-up state. When it is to be discarded, it can then be rolled or folded into a compact shape.

In order to use the pad 10 for changing an infant's diaper, the pad 10 is spread out on a table or other support surface with the bottom sheet 30 of the pad 10 facing the support surface and the infant lying atop the top sheet 20 of the pad 10. The diaper can then be replaced in the customary manner. Any fluids which are discharged from the infant or which leak from the diaper during diaper changing preferably pass through the top sheet 20 of the pad 10 and preferably are absorbed by the absorbent region 40 while being prevented from reaching the support surface by the bottom sheet 30. At the same time, any liquids on the top of the support surface preferably are prevented by the bottom sheet 30 from contacting the infant. When diaper changing is completed, the infant can be removed from the pad 10, and the pad 10 can be discarded, preferably after a single use. Even if the infant is left on the pad 10 for some time, any fluids discharged during diaper changing will be absorbed by the absorbent region 40, and the top sheet 20, which the infant contacts, will remain dry, so the infant will feel no discomfort from the presence of liquid in the absorbent region 40.

The pad 10 can be used in a similar manner as detailed in the method for changing a baby's diaper in a hospital environment when changing dressings, using bedpans, drawing fluid from or administering fluids to a patient, or in other procedures involving possible contamination. The primary change is that the patient is more likely to lie on the pad 10 for extended periods of time than a baby whose diaper is being changed.

Those skilled in the art will appreciate that various adaptations and modifications of the above-described preferred embodiments can be configured without departing from the scope and spirit of the invention. Therefore, it is to be understood that, within the scope of the appended claims, the invention may be practiced and constructed other than as specifically described herein.

We claim:

1. A pad comprising:
a top sheet, said top sheet is permeable to liquid,
a bottom sheet with protrusions, and
a liquid-absorbent region between said top and bottom sheets; and
wherein said protrusions are on a side of said bottom sheet opposing said liquid-absorbent region.

2. The pad as claimed in claim 1, wherein said top sheet and said bottom sheet each have first and second lengthwise ends and a width which is greater between the lengthwise ends than at the lengthwise ends.

3. The pad as claimed in claim 2, wherein the width varies linearly along a length of the pad.

4. The pad as claimed in claim 2, wherein the first and second lengthwise ends are equal in width.

5. The pad as claimed in claim 2, wherein the width is a maximum midway between the two lengthwise ends.

6. The pad as claimed in claim 1, wherein said protrusions include a plurality of ridges extending from said bottom sheet.

7. The pad as claimed in claim 1, wherein said protrusions include a pattern of raised bumps on said bottom sheet.

8. The pad as claimed in claim 1, wherein said protrusions include a pattern of suction cups extending from said bottom sheet.

9. The pad as claimed in claim 1, wherein said protrusions include a plurality of string members extending from said bottom sheet.

10. A pad comprising:
a top sheet for supporting a person,
a bottom sheet having a plurality of projections for
resisting sliding of said pad, and
an absorbent region between said top sheet and said bottom sheet; and
wherein said plurality of projections are on a side of said bottom sheet opposing said absorbent region.

11. The pad as claimed in claim 10, wherein the projections are at least one of bumps, ridges, and needles.

12. The pad as claimed in claim 10, wherein the bottom sheet is impermeable to liquid.

13. A pad comprising:
a top sheet, said top sheet is permeable to liquid;
a bottom sheet, said bottom sheet is impermeable to liquid, said bottom sheet having projections along one surface; and
a liquid-absorbent region disposed between the top and bottom sheets; and
wherein said region on a surface of said bottom sheet opposite the surface with the projections.

14. The pad as claimed in claim 13, wherein said top sheet includes a non-woven fabric.

15. The pad as claimed in claim 13, wherein the top sheet includes a mesh.

16. The pad as claimed in claim 13, wherein said projections include a plurality of ridges extending from said bottom sheet.

17. The pad as claimed in claim 13, wherein said projections include a pattern of raised bumps on said bottom sheet.

18. The pad as claimed in claim 13, wherein said projections include a pattern of suction cups extending from said bottom sheet.

19. The pad as claimed in claim 13, wherein said protrusions include a plurality of string members extending from said bottom sheet.

20. A method for using the pad as claimed in claim 13 comprising:
spreading the pad out over a support surface with the bottom surface and the projections against the support surface,
placing the individual on top of the pad,
caring for the individual,
removing the individual from the pad, and
disposing of the pad.
